(19) United States
(12) Patent Application Publication
(10) Pub. No.: US 2016/0014670 A1
(43) Pub. Date: Jan. 14, 2016

(54) METHOD FOR GENERATING NETWORK ROUTE USING TV WHITE SPACE

(71) Applicants: Electronics and Telecommunications Research Institute, Daejeon (KR); AJOU UNIVERSITY INDUSTRY-ACADEMIC COOPERATION FOUNDATION, Suwon-si (KR)

(72) Inventors: Jae-Hwan KIM, Daejeon (KR); Sang-Jae LEE, Daejeon (KR); Sang-Sung CHOI, Daejeon (KR); Young-Bae KO, Suwon-si (KR); Jae-Beom KIM, Suwon-si (KR)

(21) Appl. No.: 14/796,513

(22) Filed: Jul. 10, 2015

(30) Foreign Application Priority Data
Jul. 10, 2014 (KR) 10-2014-0087025
Jun. 30, 2015 (KR) 10-2015-0093761

(51) Int. Cl. H04W 40/24; H04W 4/06; H04W 4/00; H04W 16/14

(52) U.S. Cl. CPC H04W 40/248; H04W 16/14; H04W 4/06; H04W 4/008

(57) ABSTRACT

Exemplary embodiments of the present invention relate to a method for generating a route between nodes in a network environment using TVWS (TV White Space). The network route generating method by PAN (Personal Area Networks) coordinator which can transmit/receive message with node existing in TMCTP (TVWS Multichannel Cluster Tree Personal area networks) through a plurality of channels belong to TVWS (TV white space), the method comprises: receiving a route search message from a SPC (Super PAN Coordinator) or an upper PAN coordinator, through a channel among the plurality of channels; and broadcasting the route search message, through the plurality of channels. According to exemplary embodiments of the present invention, a network route between nodes can be easily set using TVWS.

### CROSS REFERENCE TO RELATED APPLICATION

This application claims the benefit of Korean Patent Application No. 10-2014-0087025, filed on Jul. 10, 2014, and Korean Patent Application No. 10-2015-0093761, filed on Jun. 30, 2015, which is hereby incorporated by reference in its entirety into this application.

### BACKGROUND

1. Technical Field

Exemplary embodiments of the present invention relates to method for generating network route between nodes in the network using TVWS.

2. Description of the Related Art

At the moment, the sensor network technology have evolved by using high quality frequency band which is not used in TV broadcasting, in order to prevent the deterioration of the transmission quality due to frequency interference between various devices which use a common frequency.

For this purpose, IEEE 802.15.4 Group, that is a standardization group of wireless sensor network, has set up EEE 802.15 TG 4m for setting a standard of wireless sensor network using TVWS (TV white space).

The IEEE 802.15 TG 4m has achieved the improvement of transmission distance using high quality frequency band and has proposed a method for generating a TMCTP (TVWS multichannel cluster tree PANs (personal area networks) topology in order to alleviate the increase of network density due to the increase of transmission distance.

In TMCTP topology, a network is composed from a SPC (super PAN coordinator) having regional TVWS frequency information. In addition, a specific node among child nodes of SPC is selected as a PAN coordinator which uses a specific channel.

Thus, the number of nodes per channel is decreased in PAN coordinator located in a specific region, so as to alleviate the transmission complexity.

Recently there have been services such as a smart grid, which is combined with IT technology and social infrastructure, and standard technologies using TVWS has been highlighted in accordance with the increase of the frequency value.

### SUMMARY

Exemplary embodiments of the present invention provide a method for setting a route between nodes using TVWS.

According to one aspect of the invention, there is provided with a network route generating method for generating a route by PAN (Personal Area Networks) coordinators which can transmit/receive messages with nodes existing in TMCTP (TVWS Multichannel Cluster Tree Personal area networks) through a plurality of channels belong to TVWS (TV white space), the method comprises: receiving a route search message from a SPC(Super PAN Coordinator) or an upper PAN coordinator, through a channel among the plurality of channels; and broadcasting the route search message, through the plurality of channels.

In an embodiment, the broadcasting the route search message comprises broadcasting the route search message when a channel change between the plurality of channels is made.

In an embodiment, the method further comprises: generating a response message for the route search message; and transmitting the response message to the SPC or the upper PAN coordinator through the channel.

In an embodiment, the method further comprises: receiving an ACK frame for the response message from the SPC or the upper PAN coordinator.

In an embodiment, the response message can include a list of PAN node(s) associated with PAN through the PAN coordinator.

In an embodiment, the method further comprises: receiving a response message for the route search message, from a lower PAN coordinator which receives the broadcasted route search message; and transmitting the response message to the SPC or the upper PAN coordinator, through the channel.

In an embodiment, the response message comprises a list of PAN nodes associated with PAN through the lower PAN coordinator.

In an embodiment, the route search message comprises an L2R (Layer 2 Routing) capability of the SPC.

According to another aspect of the invention, there is provided with a network route generating method by a PAN (Personal Area Networks) coordinator which can transmit/receive message with node existing in TMCTP (TVWS multichannel cluster tree personal area networks) through a plurality of channels belong to TVWS (TV white space), the method comprises: receiving a route search message from an upper PAN coordinator or a source PAN node, through a channel among the plurality of channels; and broadcasting the route search message, through the channel.

In an embodiment, the method further comprises: generating a response message to the route search message and transmitting the response message to the source node or the upper PAN coordinator, if a destination PAN node is an own PAN node based on analyzing result of the route search message.

In an embodiment, the method further comprises: receiving an ACK frame to the response message.

In an embodiment, the method further comprises: broadcasting the route search message through the plurality of channels, if a destination PAN node is not an own PAN node based on analyzing result of the route search message.

In an embodiment, the method further comprises: setting the upper PAN coordinator as an upper node of the route.

According to exemplary embodiments of the present invention, a network route between nodes can be easily set using TVWS.

According to exemplary embodiments of the present invention, a control message used for generating a network route can be minimized.

### BRIEF DESCRIPTION OF DRAWING

FIG. 1 illustrates a TMCTP topology in which exemplary embodiments of the present invention are applied;

FIG. 2A, FIG. 2B and FIG. 2C are exemplary drawings for explaining a route generating method of proactive type according to one embodiment of the invention;

FIG. 3 is an exemplary drawing for explaining the route generating process of proactive type according to one embodiment of the invention;

FIG. 4 is the flow chart for explaining the messages transmitted and/or received between SPC and PAN coordinators in proactive type according to one embodiment of the invention;

FIG. 5 is the flow chart for explaining the messages transmitted and/or received between PAN coordinators in proactive type according to one embodiment of the invention;

FIG. 6 is an exemplary drawing for explaining a routing table included in each nodes which exist TMCP, according to one embodiment of the invention;

FIG. 7 is an exemplary drawing for explaining route state information included in routing table, according to one embodiment of the invention;

FIG. 8 is an exemplary drawing for explaining an identifier used for discriminating the type of control message, according to one embodiment of the invention;

FIG. 9 is an exemplary drawing for explaining the structure of SANN message, according to one embodiment of the invention;

FIG. 10 is an exemplary drawing for explaining the L2R capability included in SANN message according to one embodiment of the invention;

FIG. 11 is an exemplary drawing for explaining the SANN-RP message according to one embodiment of the invention;

FIG. 12 is an exemplary drawing for explaining the PAN state information included in SANN-RP message according to one embodiment of the invention;

FIG. 13A, FIG. 13B and FIG. 13C are exemplary drawings for explaining the route generating method of reactive type according to one embodiment of the invention;

FIG. 14 is a drawing for explaining the route generating process of reactive type according to one embodiment of the invention;

FIG. 15 is a flow chart for explaining the message transmitted/received between source node and PAN coordinator in reactive type according to one embodiment of the invention;

FIG. 16 is a flow chart for explaining the process that the message is propagated through multiple channels when the hop count between the source node and the target node is high;

FIG. 17 is an exemplary drawing for explaining the structure of P2P-RQ message according to one embodiment of the invention;

FIG. 18 is an exemplary drawing for explaining the request status included P2P-RQ message according to one embodiment of the invention;

FIG. 19 is an exemplary drawing for explaining the P2P-RP message structure according to one embodiment of the invention; and

FIG. 20 is an exemplary drawing for explaining the reply status included P2P-RP message according to one embodiment of the invention.

### DESCRIPTION OF THE EXEMPLARY EMBODIMENTS

Throughout the description of the present invention, when describing a certain technology is determined to evade the point of the present invention, the pertinent detailed description will be omitted.

In a wireless network using TVWS, a network is composed from the root node connected to regional channel information database or Internet. In order not to interfere the TV frequency, the nodes can be associated in the network using the beacon or the probe message transmitted by root node. Also, the nodes perform data transmission on the associated network. In more detail, for setting multiple hop networks in TVWS environment, each node use multiple channel available and regional channel information received from root node for setting respective independent network.

Such use of multiple channels reduces the node number per channel, which alleviates the transmission complexity and the collision phenomenon, so that the transmission quality can be improved. However, in routing between nodes for multiple hop communication, the communication between PAN nodes using different channel is impossible and thus there is a problem that the route can't be set properly or efficiently and the transmission capability between end nodes in network would be dramatically decreased.

The embodiments of the invention provides a method for generating a network route (hereinafter called as “route”) using TVWS, in network layer 2 in which the channel information can be easily acquired.

Hereinafter, the embodiments of the invention will be explained in the context of multiple channel network environment but the embodiments of the invention would be applied to single channel network environment.

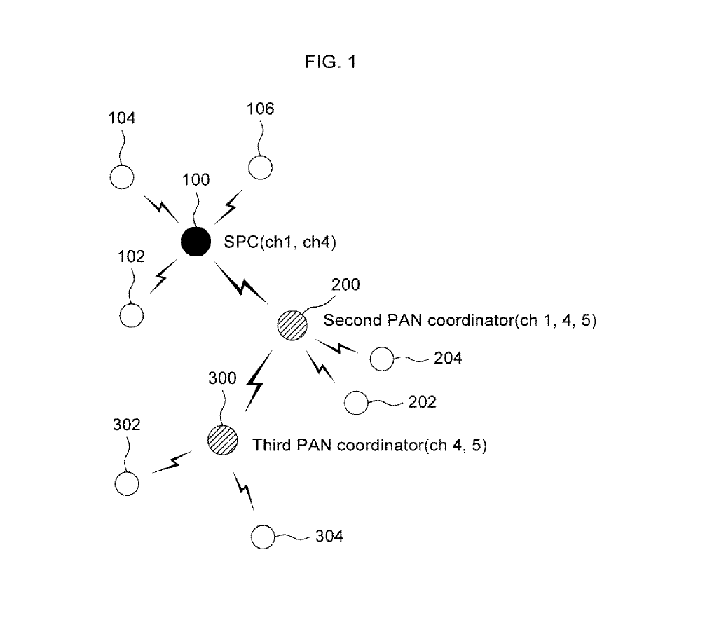

FIG. 1 illustrates a TMCTP topology in which exemplary embodiments of the present invention are applied.

TMCTP can be established from the node 100 which can acquire the regional channel information. This node 100 can be called as root node, gateway or SPC etc. Hereinafter, for the sake of easy explanation, the node that can acquire the regional channel information would be called as SPC. SPC 100 can acquire the regional channel information from GDB (geolocation database) connected via Internet or other one.

SPC 100 can assign TVWS channel to intermediate nodes 200, 300 based on the channel information acquired from geolocation database, and thus TMCTP can be generated. The intermediate nodes 200 and 300 can be called as PAN coordinators.

The end nodes 102, 104, 106, 202, 204, 302 and 304 can be associated with PAN through near SPC 100 or near PAN coordinators 200 or 300. The end nodes 102, 104, 106, 202, 204, 302 and 304 can be called as PAN nodes.

Each node 102, 104, 106, 202, 204, 302 and 304 may be a device which has wireless interface and simultaneously perform computing function and routing function. Each node 102, 104, 106, 202, 204, 302 and 304 may be, for example, a mobile phone, a notebook, a tablet or a fixed/mobile device having a sensor.

SPC 100 and the intermediate nodes 200 and 300 may be a FFD (full function device) node and the end nodes 102, 104, 106, 202, 204, 302 and 304 may be FFD nodes or RFD (reduced function device) nodes.

The embodiments of the invention propose two method of establishing route between nodes in TMCTP.

The first method is that the route between nodes is established according to the control message propagated from the uppermost node, or SPC. For the convenience of explanation, this is called as proactive type. In proactive type, the route to SPC can be established from every nodes existed in TMCTP.

The second method is that the route between PAN nodes is established according to the control message propagated from the end node, or PAN node. For the convenience of explanation, this is called as reactive type. In reactive type, the route can be between the source node and the target node.

Hereinafter, referring to the related drawings, the route generating method of proactive type and the route generating method of reactive type will be explained.

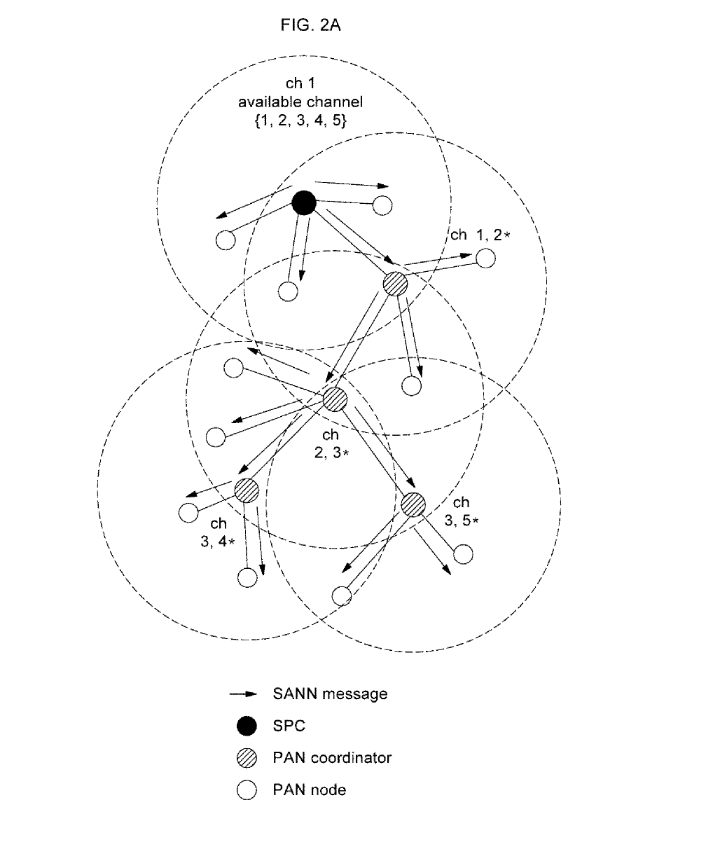

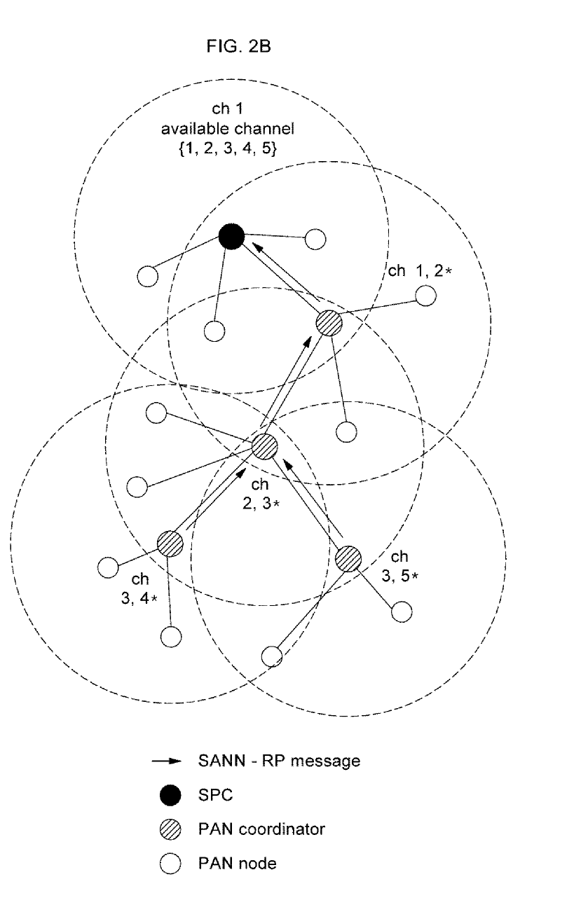

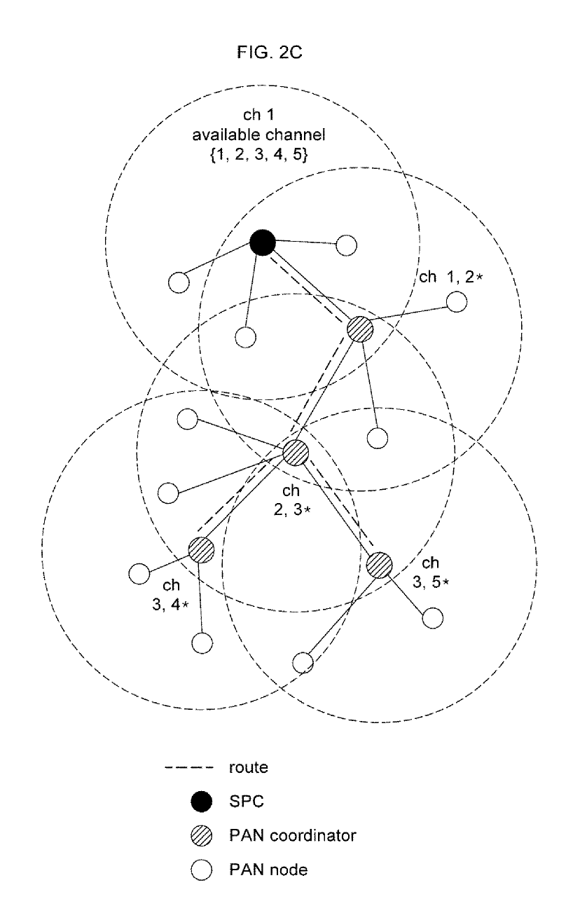

FIG. 2A, FIG. 2B and FIG. 2C are exemplary drawings for explaining a route generating method of proactive type according to one embodiment of the invention.

Referring to FIG. 2A, it is assumed that SPC is connected to network to get the channel information of region and the number of TVWS channels available is five, or channel 1 to channel 5. The channel from SPC can be assigned to the PAN coordinators. Each PAN coordinator can establish an own independent network, for example PAN, using the channel which is not used by other PAN coordinators.

Here, for the convenience of explanation, the channel used for establishing the independent network for itself by PAN coordinator is called as own channel. The PAN coordinators can alternately use the channel used in the upper node of itself and the own channel for itself (that is marked as ‘*’ in the drawing).

In such network environment, the SPC can broadcast the route search message, that is control message for generating route, through the channel managed by itself. Hereinafter, for the convenience of explanation, the route search message used in proactive type is called as SANN(SPC announcement) message, and the response message to the SANN message is called as SANN-RP (SANN-Reply) message. The SANN message can be periodically broadcasted and the broadcasting period can be changed according to the state of network.

The PAN coordinators received the SANN message which is broadcasted from the SPC, can broadcast the SANN message to PAN node of itself and the lower PAN coordinators of itself. Also, the PAN coordinators received the SANN message which is broadcasted from the upper PAN coordinator of itself, can broadcast the SANN message to the PAN node of itself and the lower PAN coordinator of itself.

As shown in FIG. 2B, the PAN coordinator received the SANN message, can generate SANN-RP message which is a response message to the SANN message and the SANN-RP message can be sent to SPC or the upper PAN coordinator of itself. In the response message, the list of PAN nodes associated with the PAN through the PAN coordinator received the SANN message can be included. The PAN coordinator received the SANN-RP message from the lower PAN coordinator of itself, can transmit the SANN-RP message to the SPC or the upper PAN coordinator of itself.

As told before, the route between nodes is established as shown in FIG. 2C. Referring to FIG. 2C, it is known that the route connected to a plurality of coordinators is generated. The generated route may be updated whenever SANN message is generated and the updating period may be changed in accordance with the network state.

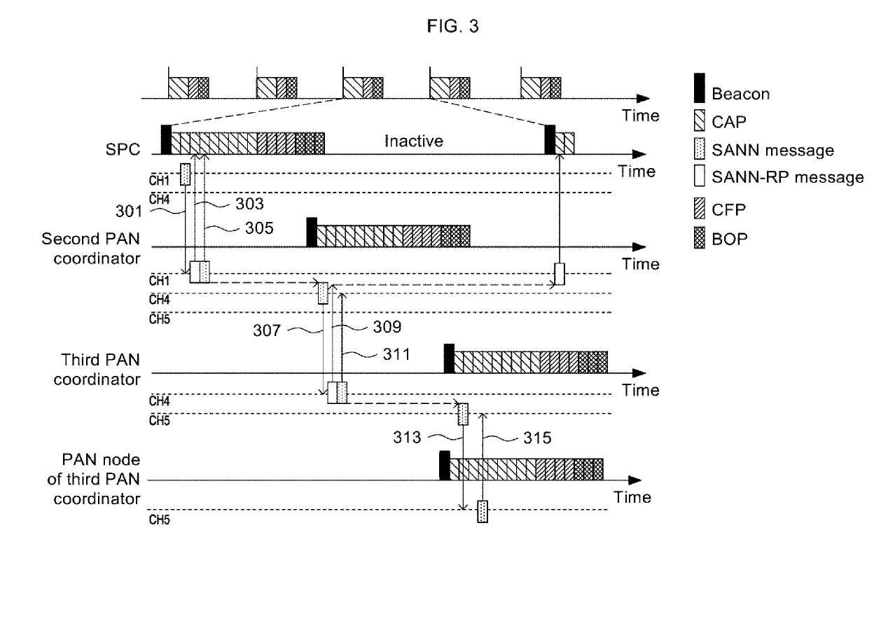

FIG. 3 is an exemplary drawing for explaining the route generating process of proactive type according to one embodiment of the invention.

In step 301, SPC can broadcast the SANN message through the channel that is currently managed by itself, for example channel 1. The SANN message broadcasted from SPC can be received by a second PAN coordinator.

In step 303, the second PAN coordinator can generate SANN-RP message and send it to SPC, as a response for the SANN message. The SANN-RP message can be transmitted to SPC through channel 1 which is the channel receiving the SANN message.

In step 305, the second PAN coordinator can broadcast the SANN message through the channel currently managed by itself, that is channel 1 which is the channel receiving the SANN message.

Then, channel change can be made in the second PAN coordinator. For example, the managed channel can be changed from channel 1 to channel 4. In the case of changing to channel 4, the second PAN coordinator can broadcast the SANN message through channel 4 in step 307. The SANN messages broadcasted in step 307, can be received by the lower nodes of the second PAN coordinator (for example, the PAN node of the second PAN coordinator and the third PAN coordinator). The PAN node of the second PAN coordinator can be the end node associated in PAN through the second PAN coordinator.

In step 309, the third PAN coordinator can generate SANN-RP message and send it to the second PAN coordinator which has broadcasted the SANN message, as a response to SANN message. The SANN-RP message can be transmitted to SPC through channel 4 which has received the SANN message.

In step 311, the third PAN coordinator can broadcast the SANN message through channel 4 which is currently managed.

Then the channel change can be made in the third PAN coordinator. For example, the channel 4 being managed can be changed to channel 5. In case of changing to channel 5, the third PAN coordinator can broadcast the SANN message through the channel 5, in step 313. In step 313, the broadcasted SANN messages can be received by the PAN node of the third PAN coordinator.

In step 315, the PAN node of the third PAN coordinator can broadcast the SANN message through the channel 5 which is the channel receiving the SANN message.

As shown in the above, the route search message can be transmitted through entire channel in the multi-channel environment.

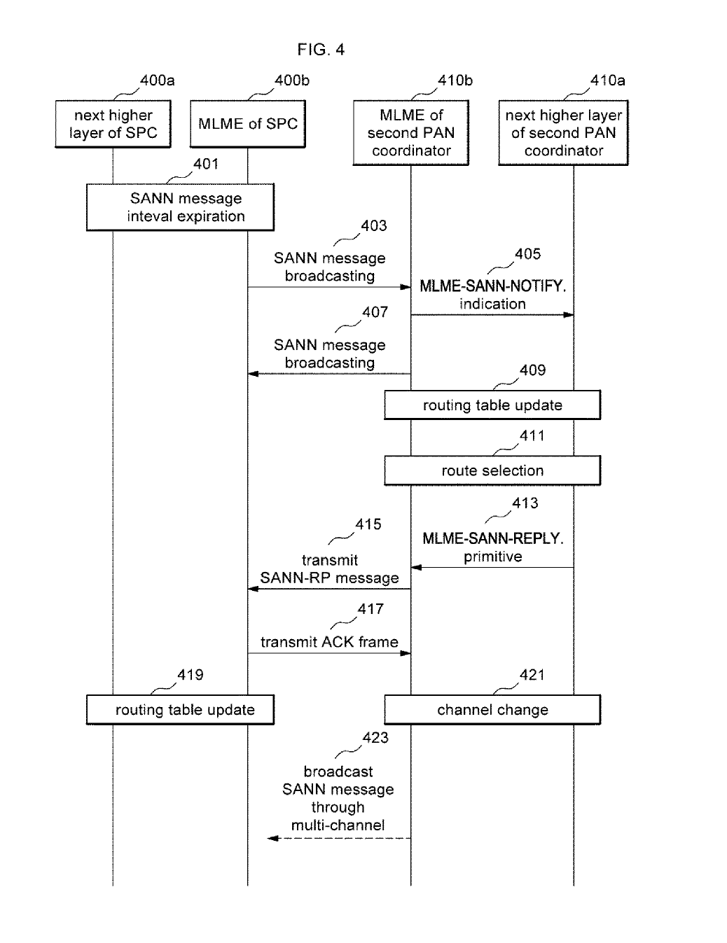

FIG. 4 is the flow chart for explaining the messages transmitted and/or received between SPC and PAN coordinators in proactive type according to one embodiment of the invention.

Each of the nodes existing on TMCTP, which means SPC, PAN coordinator and PAN nodes, includes a next higher layer and MLME (MAC layer management entity).

Hereinafter, for the convenience of explanation, if necessary, each of these nodes is described with being divided into a next higher layer and MLME. In step 401, it is assumed that the SANN message interval is terminated. As shown in the above, the SANN message can be broadcasted by period having specific interval, and the step 401 means that it comes the time for the SANN message to be broadcasted.

In step 403, the MLME 400b of SPC can broadcast the SANN message through the channel which is currently managed by itself. In MLME 400b of SPC, the broadcasted SANN message can be received by MLME 410b of the PAN coordinator.

In step 405, MLME 410b of PAN coordinator can transmit a MLME-SANN-NOTIFY.indication to the next higher layer 410a of PAN coordinator. MLME-SANN-NOTIFY.indication is the message which means that the MLME 410b of the second PAN coordinator has received the SANN message from the MLME of the upper PAN coordinator, or the MLME 400b of the SPC.

In step 407, the MLME 410b of the PAN coordinator can broadcast the SANN message through the channel having received the SANN message from the MLME 400b of the SPC which is currently managed.

In step 409, the PAN coordinator can update the routing table based on the information included in the SANN message. Also, in step 411, the PAN coordinator can select an uplink route.

In step 413, the next higher layer 410a of the PAN coordinator can transmit a MLME-SANN-REPLY.primitive to MEME 410b of the PAN coordinator. The MLME-SANN-REPLY.primitive is the message indicating that the next higher layer 410a of the PAN coordinator transmit the SANN-RP message to the MLME of the upper PAN coordinator, or the MLME 400b of SPC.

In step 415, the MEME 410b of the PAN coordinator can generate a SANN-RP message and then transmit it to the MLME 400b of the SPC.

In step 417, the MLME 400b of the SPC can transmit an ACK frame to the MLME 410b of the PAN coordinator as a response to the SANN-RP.

In step 419, the SPC can update the routing table based on the information included in the SANN-RP message which is received from the MLME 410b of the PAN coordinator.

In step 421, the channel change of PAN coordinator can be made. For example, the managed channel can be changed from channel 1 to channel 4.

In step 423, the PAN coordinator can broadcast the SANN message through the channel being currently used, for example the channel 4.

The steps 421 and 423 can be repeatedly performed and the SANN message can be broadcasted through every channel which can be used by the PAN coordinator. That is, the SANN message can be broadcasted by multi-channel.

FIG. 5 is the flow chart for explaining the messages transmitted and/or received between PAN coordinators in proactive type according to one embodiment of the invention.

For the convenience of explanation, the upper PAN coordinator is called as the parent coordinator and the lower PAN coordinator is called as the child coordinator.

In step 501, it is assumed that the PAN coordinator receives the SANN message broadcasted from the upper PAN coordinator or SPC.

In step 503, the MLME 500b of the parent PAN coordinator can broadcast the SANN message received from the upper PAN coordinator or the SPC through the channel being currently used. The broadcasted SANN message can be received by the MLME 510b of the child PAN coordinator. Thus, the MLME 510b of the child PAN coordinator can transmit a MLME-SANN-NOTIFY.indication to the next higher layer 510a of the child PAN coordinator.

In step 507, the MLME 510b of the child PAN coordinator can broadcast the SANN message through the channel being currently used by itself, or the channel which has received the SANN message.

In step 509, the child PAN coordinator can update the routing table based on the information included in the SANN message which has been received from the MLME 500b of the parent PAN coordinator. Then, in step 511, the child PAN coordinator can update the uplink route.

In step 513, the next higher layer 510a of the child PAN coordinator can transmit a MLME-SANN-REPLY.primitive to the MLME 510b of the child PAN coordinator. Thus, in step 515, the MLME 510b of the child PAN coordinator can generate a SANN-RP message and transmit it to the MLME 500b of the parent PAN coordinator, as a response to the SANN message. Then, in step 517, the MLME 500b of the parent PAN coordinator can transmit an ACK frame to the MLME 510b of the child PAN coordinator, as a response of the SANN-RP message.

In step 519, the parent PAN coordinator can update the routing table based on the information included the SANN-RP message which has been received from the MLME 510b of the child coordinator.

In step 521, it is assumed that the channel change of the parent PAN coordinator is made. For example, the managed channel can be changed from channel 1 to channel 4 in the parent PAN coordinator.

In step 523, the MLME 500b of the parent PAN coordinator can transmit the SANN-RP message received from the child PAN coordinator through the channel being currently used, for example the channel 1, to the upper node. The upper node can be the upper PAN coordinator of the parent PAN coordinator, or SPC.

In step 525, it is assumed that the channel change is made in the child PAN coordinator. For example, the channel 4 has been used in the child PAN coordinator and the channel 5 will be used from now.

In step 527, the MLME 510b of the child PAN coordinator can broadcast the SANN message through the channel currently used at the moment, for example the channel 5.

The steps of 525 and 527 can be repeatedly performed and the SANN message can be broadcasted through the every channel available to the child PAN coordinator.

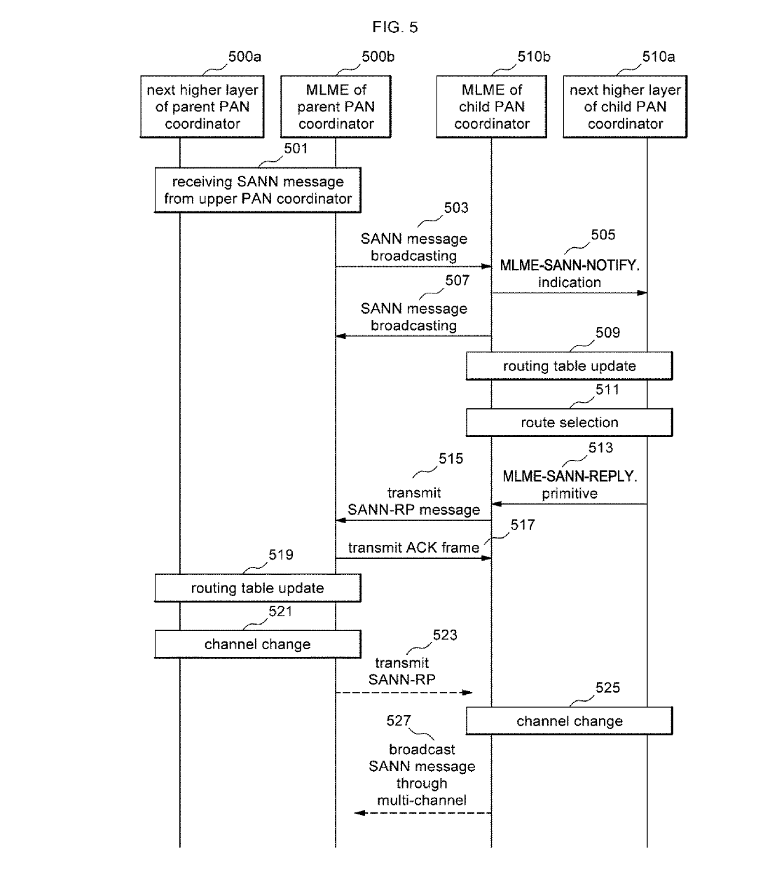

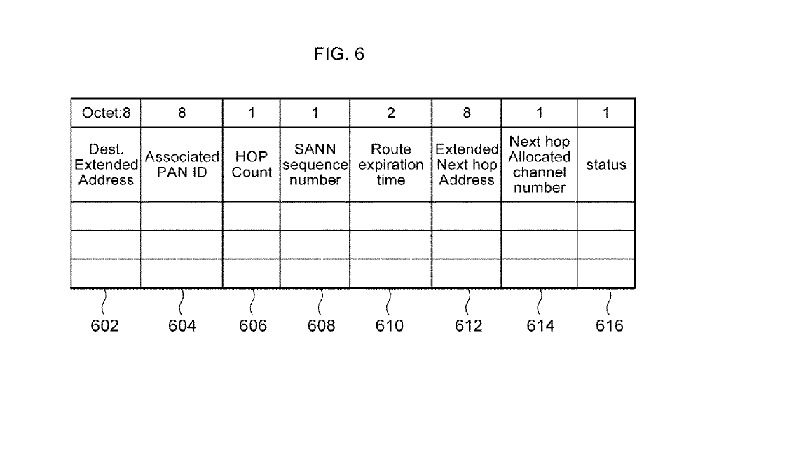

FIG. 6 is an exemplary drawing for explaining a routing table included in each nodes which exist TMCP, according to one embodiment of the invention.

The routing table can include at least one of an destination extended address 602, an associated PAN identifier 604 associated with the destination node, a hop count 606 to the destination node, a SANN sequence number 608, a route expiration 610, an extended next hop address 612, an next hop allocated channel number 614 on the route for the destination node, a route status 616. According to the embodiments, the routing table further includes a variety of information.

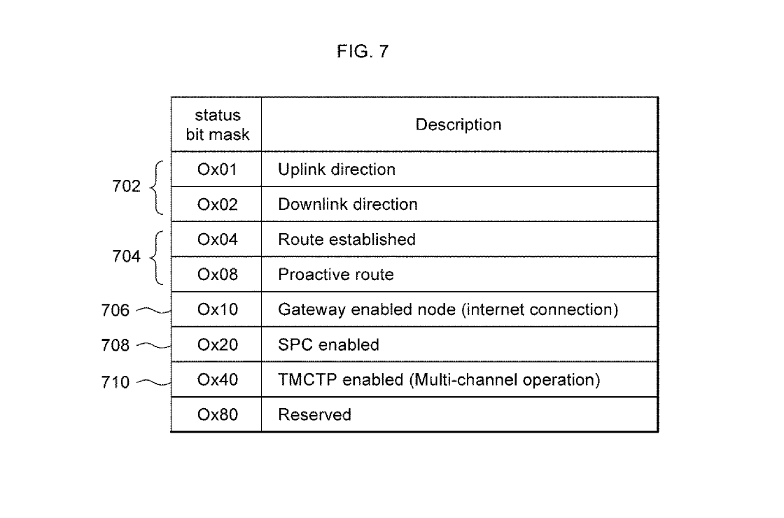

The route state information can includes the information of the node type and the route. This will be explained in more detail, referring to FIG. 7.

FIG. 7 is an exemplary drawing for explaining route state information included in routing table, according to one embodiment of the invention.

The route state information can include a direction information 702 of respective route, a type 704 of the message used for route generation, an information 706 on whether the destination node can do as a gateway or not, an information 708 on whether the destination node can do as a SPC or not, an information 710 on whether the destination node uses TMCTP or not, and etc.

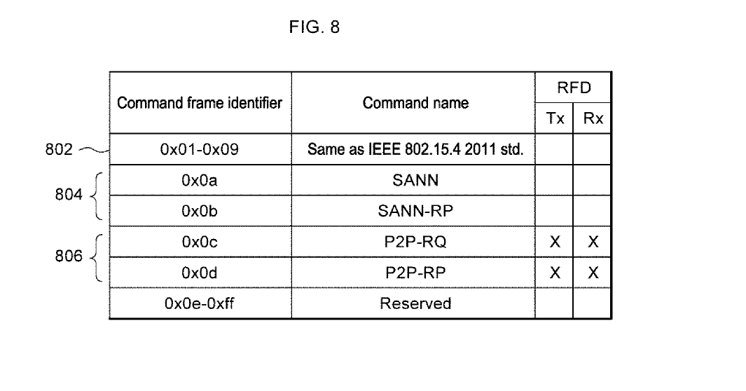

FIG. 8 is an exemplary drawing for explaining an identifier used for discriminating the type of control message, according to one embodiment of the invention.

The conventional command frame identifier 802 can use the standard IEEE 802.15.4 as it is.

The command frame identifier 804 can be used for discriminate the control message of proactive type and the command frame identifier 806 can be used for discriminate the control message of the reactive type.

On the other hand, RFD node can't generate and transmit the SANN message and SANN-RP message, and FFD node can generate and transmit the SANN message and SANN-RP message. But every node can generate and transmit P2P-RQ message and P2P-RP message. P2P-RQ message and P2P-RP message will be described later referring to drawings.

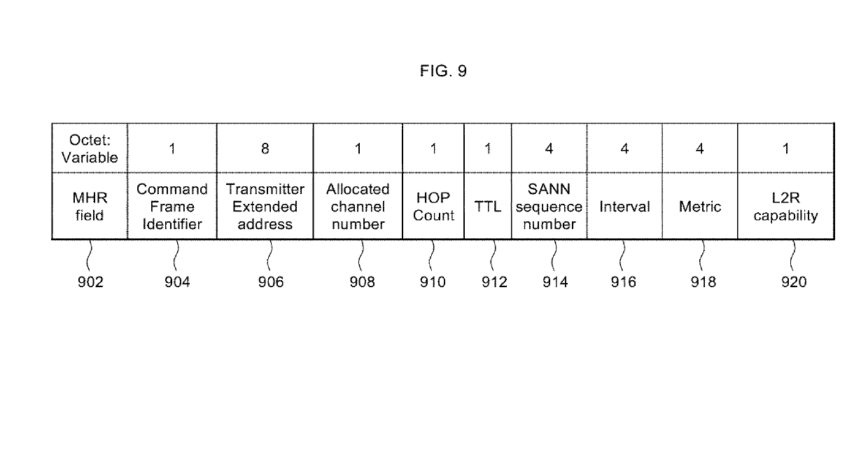

FIG. 9 is an exemplary drawing for explaining the structure of SANN message, according to one embodiment of the invention.

Referring to FIG. 9, the SANN message can include at least one of MHR (MAC header) field 902, an command frame identifier 904, a transmitter extended address 906, an allocated channel number 908, a hop count 910, a TTL (Time To Live) 912, a SANN sequence number 914, an Interval 916, a Metric 918 and a L2R capability 920.

The source node address and the destination node address can be inserted into the addressing field in the MHR field 902. These addresses can be fixed without any change during the propagation of SANN message. Accordingly, the node receiving the SANN message can search the destination node based on the destination node address defined in the address field within the MHR field 902.

The command frame identifier 904 is the same as described referring to FIG. 8.

The transmitter extended address 906 is the address of the sending node which transmits the SANN message and thus can be changed whenever the SANN message is forwarded. The node receiving the SANN message can update the next node address of the routing table with the transmitter extended address 906. And, the node receiving the SANN message can set the direction information of the route state information in the routing table as the uplink direction.

The allocated channel number 908 can be the number of the channel assigned to the sending node transmitting the SANN message and can be increased by one. TTL 912 may be the number of the maximum transmission hops of the SANN message. The SANN sequence number 914 can be circulated by periods and the node can be used for searching the route based on the latest message.

The interval 916 means the generation period of the SANN message and the route termination time of the routing table may be determined in accordance with the respective generation period. The metric 918 can be calculated whenever the SANN message is forwarded and then accumulated, which can be used for selecting the optimized route by the final destination node. This would be explained later with reference to the equations 1 and 2.

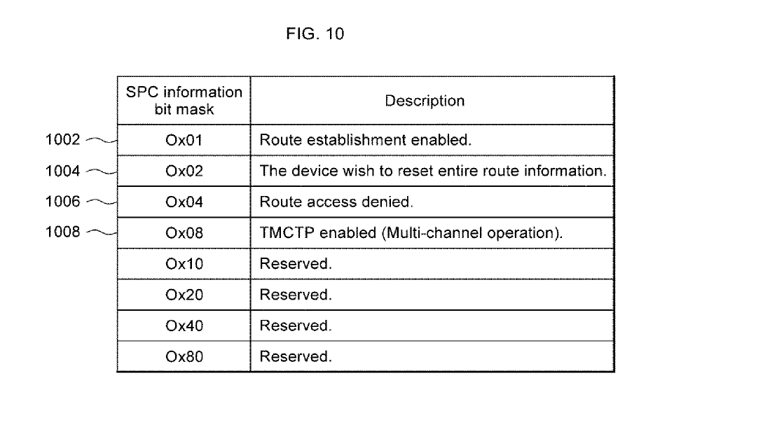

The L2R (Layer 2 Routing) capability will be explained with reference to FIG. 10.

FIG. 10 is an exemplary drawing for explaining the L2R capability included in SANN message according to one embodiment of the invention.

The L2R capability shows the participation capability of SPC when the SPC transmitting the SANN message participates the route generation using layer 2. The L2R capability can includes at least one of the information on whether the SANN route is set or not 1002, the information on whether the route is reset or not 1004, the information on whether or not routing participation 1006, and the information on whether or not TMCTP usage.

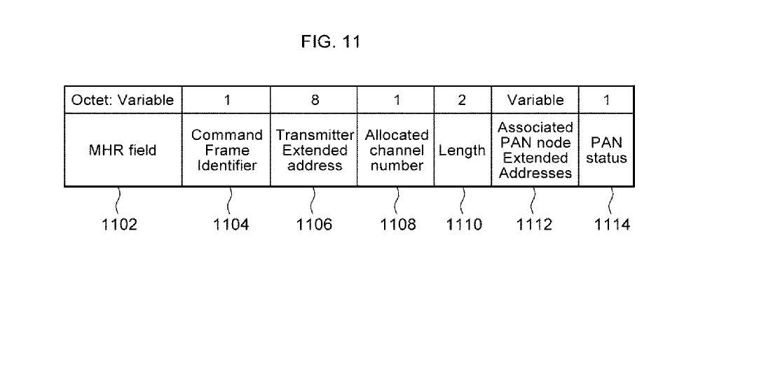

FIG. 11 is an exemplary drawing for explaining the SANN-RP message according to one embodiment of the invention.

The SANN-RP message can be transmitted to the node corresponding to the next node address of the routing table, as the message transmitted by SPC or the PAN coordinator which has received the SANN message.

The SANN-RP message can include at least one of MHR field 1102, a command frame identifier 1104, a transmitter extended address 1106, an allocated channel number 1108, length 1110, an associated PAN node extended address 1112, and a PAN status 1114.

The destination node address and the source node address can be inserted into the address field of the MHR field 1102. The destination node address and the source node address inserted into the address field of MHR field 1102 within the SANN-RP message, can be opposite to the destination node address and the source node address inserted into the address field of MHR field within the SANN message. These addresses can be fixed in the process of SANN-RP message propagation without any change.

The command frame identifier 1104 is the same as described with reference to FIG. 8.

The sending node address 1106 can be changed whenever the SANN-RP message is forwarded as the address of sending node which transmits the SANN-RP message.

The channel number 1108 can be the number of channels assigned to the sending node which transmits the SANN-RP message.

The address of the PAN nodes associated to PAN through the sending node which transmits the SANN-RP message, can be inserted into the associated PAN node extended address 1112. The length of associated PAN node extended address 1112 can be varied with the number of PAN nodes associated with the PAN through the corresponding sending node, and the length 1110 means the length of associated PAN node extended address 1112.

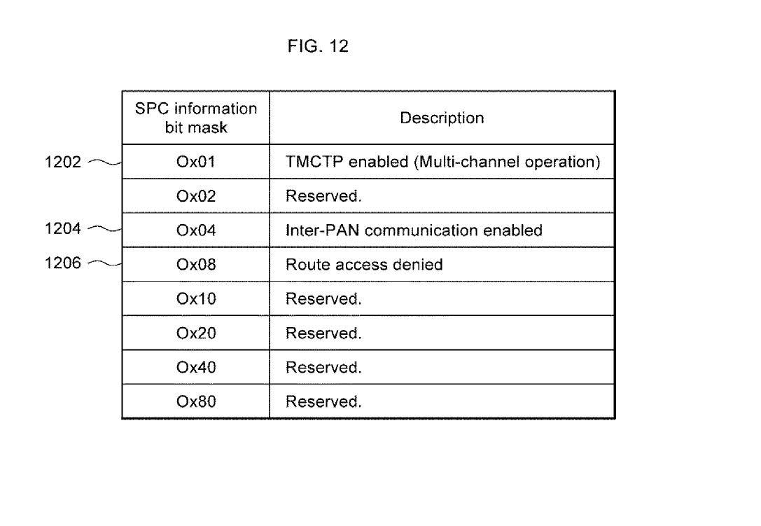

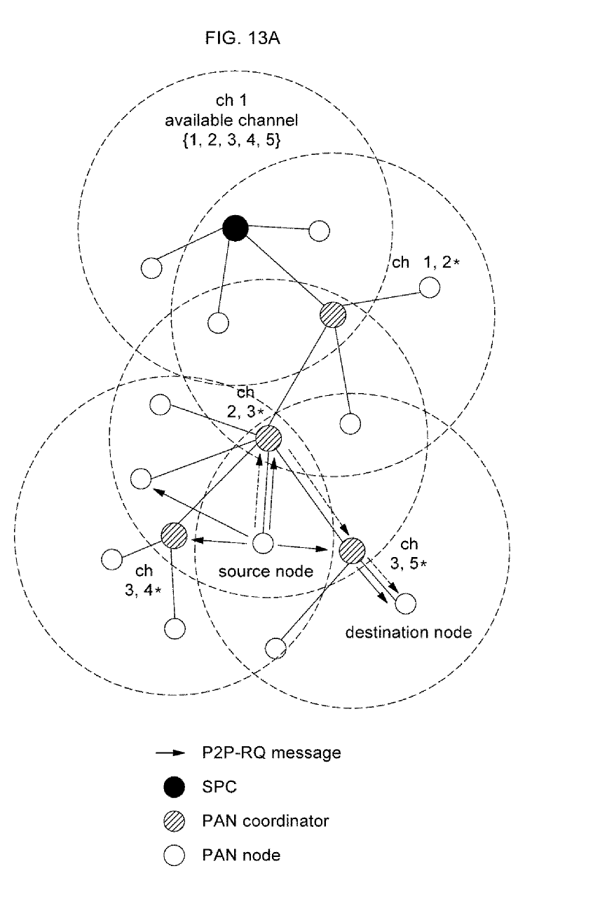

The PAN status 1114 will be explained with reference to FIG. 12.

FIG. 12 is an exemplary drawing for explaining the PAN state information included in SANN-RP message according to one embodiment of the invention.

The PAN status can include at least one of the information on whether or not TMCTP usage 1202, the information on whether or not the communication possibility between PANs 1204, and the information on whether or not the routing participation 1206.

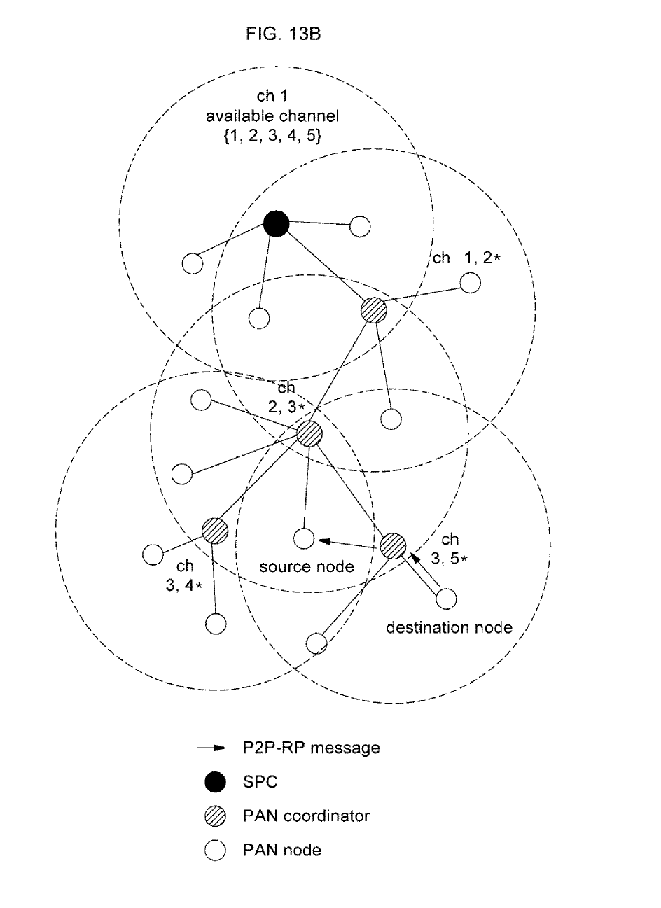

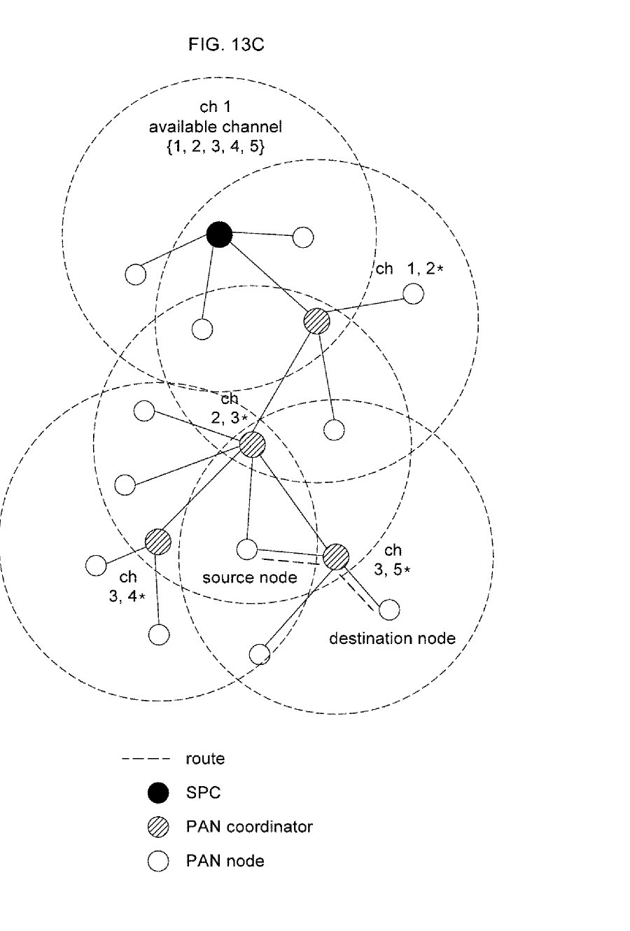

FIG. 13A, FIG. 13B and FIG. 13C are exemplary drawings for explaining the route generating method of reactive type according to one embodiment of the invention.

First, referring to FIG. 13A, it is assumed that the SPC is connected to network in order to acquire the channel information of the region, and that the number of the TVWS channels available is 5, that is the channels 1 to 5. The PAN coordinators can be assigned with channels from SPC. The respective PAN coordinator can constitute an independent network (for example, PAN) of itself using respective own channel. The PAN coordinators alternately use the channel used in the upper node of itself, and the own channel of itself (which is marked with “*” in the drawing).

In this network environment, the source node (which can be PAN node) can broadcast the route search message which is a control message for searching the destination node, through the channel used by PAN coordinator of itself. Hereinafter, for the convenience of explanation, the route search message used in reactive type is called as P2P-RQ (P2P-Request) message, and the response message to P2P-RQ message is called P2P-RP (P2P-Reply) message.

The node (PAN node, PAN coordinator or SPC) receiving P2P-RQ message can store the node transmitting the message to itself in the routing table as the upper node of the route. Also, the PAN coordinator receiving the P2P-RQ message can broadcast P2P-RQ message through the channel being used by the upper PAN coordinator of itself. That is, the PAN coordinator can broadcast the P2P-RQ message through multi-channel.

On the other hand, as shown in FIG. 13B, the destination node receiving the P2P-RQ message can generate P2P-RP message and can transmit the P2P-RP message to the PAN coordinator of itself through the channel used by the PAN coordinator of itself. Then, the P2P-RP message can be transmitted to the source node via the nodes existing on the route transmitted. Here, P2P-RQ message of PAN coordinator can be transmitted through multi-channel.

As describe above, the route between nodes as shown in FIG. 13C can be made. Referring to FIG. 13C, it is apparent that the route between the source node and the destination node is generated. According to the conventional method, the route between the source PAN node and the destination PAN node can be made through the PAN coordinator of the source PAN node and the PAN coordinator of the destination PAN node. But, according to the embodiments of the invention, the route having less hop counts can be generated in comparison with the conventional method.

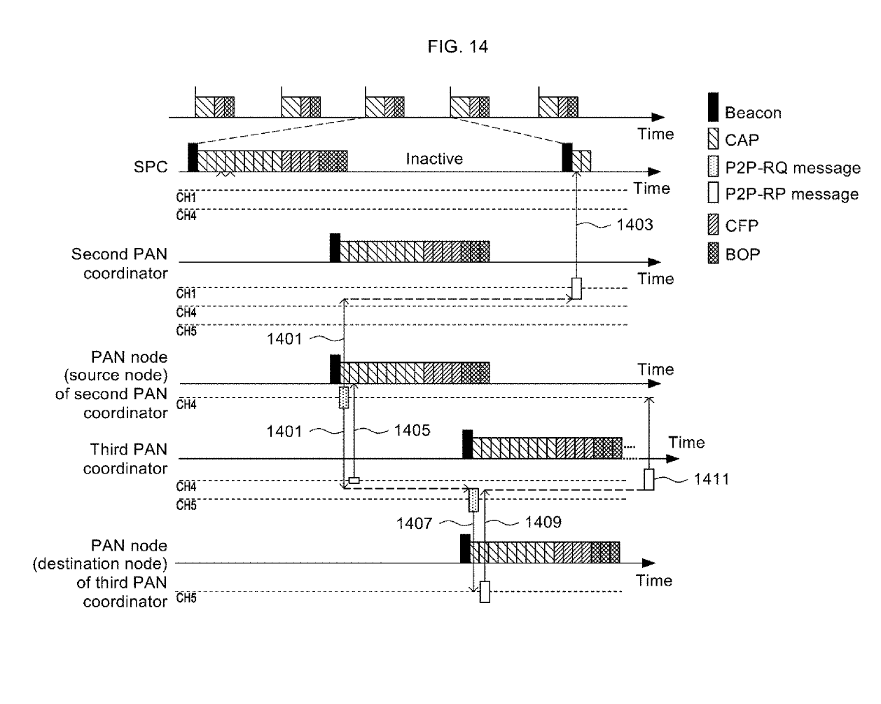

FIG. 14 is a drawing for explaining the route generating process of reactive type according to one embodiment of the invention.

In the embodiment described referring to FIG. 14, it is assumed that the source node is the PAN node of the second PAN coordinator and the destination node is the PAN node of the third PAN coordinator.

In step 1401, the source node broadcast the P2P-RQ message when the channel of its own is available. For example, the source nod can broadcast the P2P-RQ message through the channel 4 at the time which the channel 4 is available. The P2P-RQ message broadcasted from the source node can be received by the second PAN coordinator and the third PAN coordinator.

The PAN coordinator receiving the P2P-RQ message analyses the P2P-RQ message and then can broadcast the P2P-RQ message through multi-channel if the destination node is not the PAN node of its own. That the PAN coordinator broadcasts the P2P-RQ message through multi-channel, means that the PAN coordinator broadcast the P2P-RQ message through respective channel assigned to itself at the time which respective channel is available.

For example, the destination node is not the PAN node of the second PAN coordinator, so that in step 1403 the second PAN coordinator can broadcast the P2P-RQ message through multi-channel. For example, the second PAN coordinator can broadcast the P2P-RQ message through the channel 1, in case that the channel change to the channel 1 is made after the second PAN coordinator received the P2P-RQ message through the channel 4.

On the other hand, the PAN coordinator receiving the P2P-RQ message analyses the P2P-RQ message, and can promptly response through the channel receiving the P2P-RQ message if the analyzing result is that the destination node is the PAN node of its own.

For example, the destination node is the PAN node of the third PAN coordinator, so that in step 1405, the third PAN coordinator can generate P2P-RP message and transmit to the second PAN coordinator through the channel 4 receiving the P2P-RQ message.

On the other hand, in step 1407, the third PAN coordinator can transmit the P2P-RQ message to the destination node through own channel when the own channel (channel 5) is available.

In step 1409, the destination node receiving the P2P-RQ message can generate the P2P-RP message and transmit it to the third PAN coordinator which is the PAN coordinator of its own.

In step 1411, the third PAN coordinator can transmit the P2P-RP message to the source node based on the information of routing table owned by itself. That is, the P2P-RP message can be propagated to the source node based on the information of the routing table owned by respective nodes. Thus, the route between the source node and the destination node can be generated.

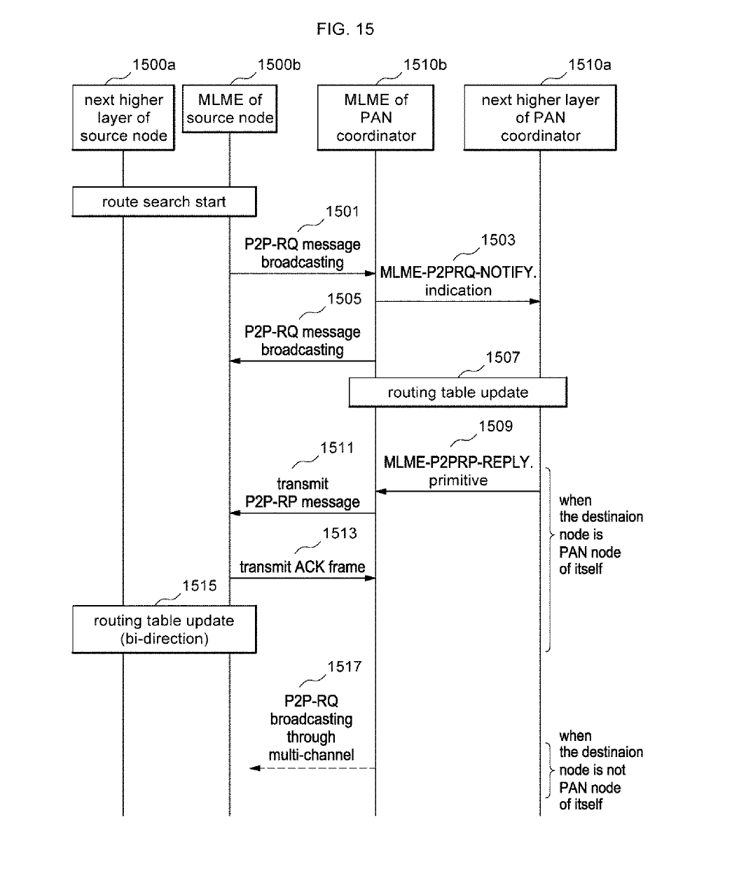

FIG. 15 is a flow chart for explaining the message transmitted/received between source node and PAN coordinator in reactive type according to one embodiment of the invention.

In step 1501, the MLME 1500b of the source node can broadcast the P2P-RQ message through the own channel when the own channel is available.

The MLME 1510b of the PAN coordinator which received the P2P-RQ message from the MLME 1500b of the source node, can generate MLME-P2PRQ-NOTIFY.indication in step 1503 and then transmit it to the next higher layer 1510a of the PAN coordinator.

In step 1505, the MLME 1510b of the PAN coordinator can broadcast the P2P-RQ message through the channel receiving the P2P-RQ message.

In step 1507, the PAN coordinator can update the routing table based on the information included in the P2P-RQ message received from the source node.

On the other hand, the PAN coordinator analyses the P2P-RQ message received from the source node, and can stop the propagation of the P2P-RQ message and promptly response, if the destination node is the PAN node of own. For example, in step 1509, the next higher layer 1510a of the PAN coordinator, can transmit MLME-P2PRP-REPLY.primitive to the MLME 1510b of the PAN coordinator. In step 1511, the MLME 1510b of the PAN coordinator can generate P2P-RP message and transmit it to the MLME 1500b of the source node. Then in step 1513, the MLME 1500b of the source node can transmit an ACK frame to the MLME 1510b of the PAN coordinator as a response of the P2P-RP message. Then in step 1515, the source node can update the routing table based on the information included in the P2P-RP message.

On the other hand, the PAN coordinator analyses the P2P-RQ message received from the source node, and can broadcast the P2P-RQ message through multi-channel when the destination node is not the PAN node of its own. For example, in step 1517, the PAN coordinator can broadcast the P2P-RQ message through the corresponding channel when the channel change of the channel assigned to itself is made.

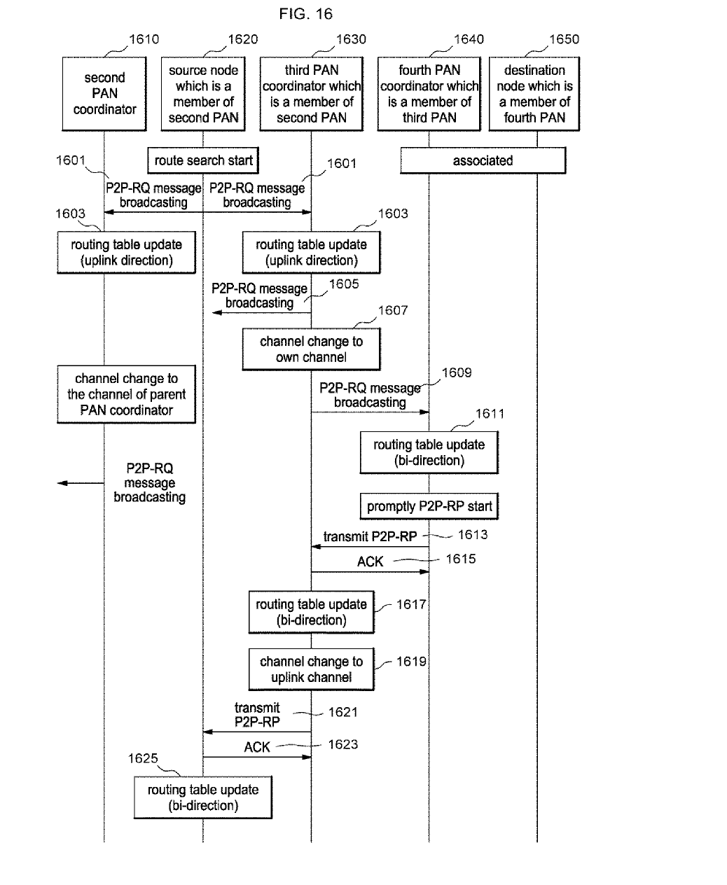

FIG. 16 is a flow chart for explaining the process that the message is propagated through multiple channels when the hop count between the source node and the target node is high.

In the embodiments described with reference to FIG. 16, it is assumed that the source node 1602 exists in the second PAN managed by the second PAN coordinator 1610, and the destination node 1650 exists in the fourth PAN managed by the fourth PAN coordinator.

Also, it is assumed that the third PAN coordinator 1630 manages the third PAN and is a member of the second PAN. Similarly, it is assumed that the fourth PAN coordinator 1640 manages the fourth PAN and is a member of the third PAN.

In step 1601, the source node 1620 can broadcast the P2P-RQ message through the channel currently available. The broadcasted P2P-RQ message can be received by the second PAN coordinator 1610 and the third PAN coordinator 1630.

In step 1603, the second PAN coordinator 1610 and the third PAN coordinator 1630 can update the routing table based on the information included in the received P2P-RQ message from the source node 1620.

In step 1605, the third PAN coordinator 1630 can broadcast the P2P-RQ message through the channel currently available, or the channel used for receiving the P2P-RQ message from the source node 1620.

In step 1607, the channel change is made to the own channel of the third PAN coordinator 1630.

In step 1609, the third PAN coordinator 1630 can broadcast the P2P-RQ message through the channel currently available, or the own channel.

In step 1611, the fourth PAN coordinator 1640 can update the routing table based on the information included in the P2P-RQ message received from the third PAN coordinator 1630.

In step 1613, the fourth PAN coordinator 1640 can generate a P2P-RP message and transmit it to the third PAN coordinator 1630. As described above, the destination node 1650 exists in the fourth PAN which is managed by the fourth PAN coordinator 1640 so that the fourth PAN coordinator knows the information of the destination node 1650. Accordingly, the fourth PAN coordinator 1640 can transmit the P2P-RP message to the third PAN coordinator 1630 without transmitting the P2P-RQ message to the destination node 1650.

In step 1615, the third PAN coordinator 1630 can transmit ACK frame to the fourth PAN coordinator 1640 as a response of the P2P-RP message.

In step 1617, the third PAN coordinator 1630 can update the routing table based on the information included in the P2P-RP message received from the fourth PAN coordinator 1640.

In step 1619, the channel change to uplink channel is made. For example, the channel change can be made to the channel received the P2P-RQ message from the source node 1620.

In step 1621, the third PAN coordinator 1630 can transmit the P2P-RP message to the source node 1620 through the channel currently available.

In step 1623, the source node 1620 can transmit the ACK frame to the third PAN coordinator as the response of P2P-RP message.

In step 1625, the source node 1620 can update the routing table based on the P2P-RP message received from the third PAN coordinator 1630. Thus, the route between source node 1620 and the destination node 1650 can be established.

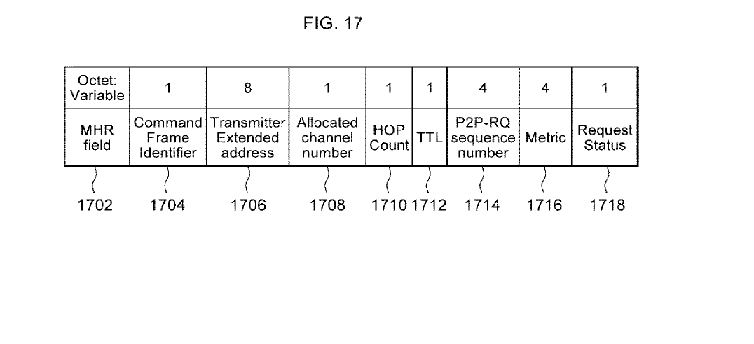

FIG. 17 is an exemplary drawing for explaining the structure of P2P-RQ message according to one embodiment of the invention.

Referring to FIG. 17, P2P-RQ message can include at least one of a MHR field 1702, a command frame identifier 1704, a transmitter extended address 1706, an allocated channel number 1708, a hop count 1710, a TTL 1712, a P2P-RQ sequence number 1714, a metric 1716 and request status 1718.

The source node address and the destination node address can be inserted in the MHR field 1702. These addresses can be fixed without any change during the propagation process of P2P-RQ message. Thus, the node receiving the P2P-RQ message can search the destination node based on the destination node address defined in the address field of MHR field 1702.

The command frame identifier 1704 is the same as described with reference to FIG. 8.

The transmitter extended address 1706 is an address of transmitting node which transmits P2P-RQ message and thus can be changed whenever P2P-RQ message is forwarded. The node receiving P2P-RQ message can update the next node address with the transmitter extended address 1706.

The allocated channel number 1708 can be a number assigned to the transmitting node, and the hop count 1710 can be increased by one whenever each hop is passed through. The TTL 1712 can show the maximum number of hops to be passed through of respective P2P-RQ message. P2P-RQ sequence number 1714 can be circulated by periods, and can be used for the node to search the route based on the latest message. The Metric 1716 can be calculated and accumulated whenever P2P-RQ message is forwarded, and can be used for the final destination node to select the optimized route. This will be described later with reference to the equation 1 and the equation 2.

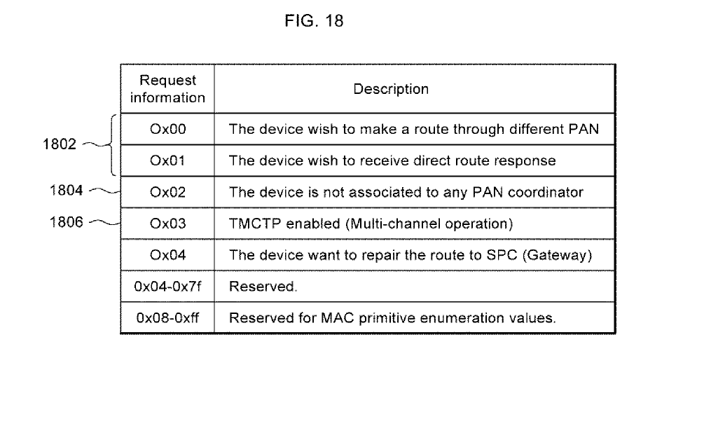

The request status 1718 will be explained referring to FIG. 18.

FIG. 18 is an exemplary drawing for explaining the request status included P2P-RQ message according to one embodiment of the invention.

The request status can include at least one of the information on functionality of respective node 1802, the PAN information 1804 associated with the node transmitting P2P-RQ message, and the information 1806 on TMCTP usage. The information of node functionality can include the information on whether or not the re-propagation of connecting the route is used, when respective node P2P-RQ message is stopped and the route generation method of promptly can generate a route through other PAN or when there is a route already generated.

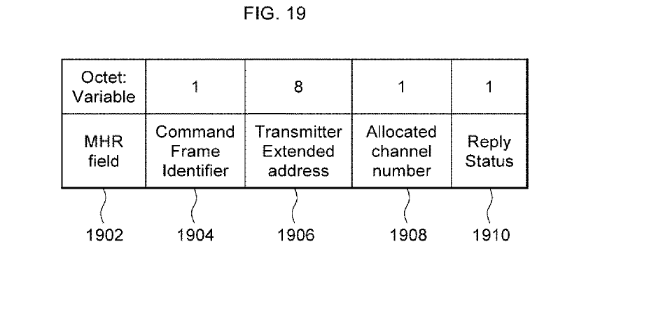

FIG. 19 is an exemplary drawing for explaining the P2P-RP message structure according to one embodiment of the invention.

Referring to FIG. 19, P2P-RP message can include at least one of a MHR field 1902, a command frame identifier 1904, a transmitter extended address 1906, an allocated channel number 1908 which is allocated to the node transmitting P2P-RP message, and a reply status 1910.

The destination address and the source node address can be inserted into the address field within the MHR field 1902. The destination node address and the source node address inserted into the address field within the MHR field of the P2P-RP message, may be opposite to the destination node address and the source node address inserted in the address field within the MHR field of the P2P-RQ message. These addresses can be fixed during the propagation process of the P2P-RP message without any change.

The command frame identifier 1904 is the same as described with reference to FIG. 8.

The transmitter extended address 1906 is an address of the transmitting node which transmits the P2P-RP message and can be changed whenever the P2P-RP message is forwarded.

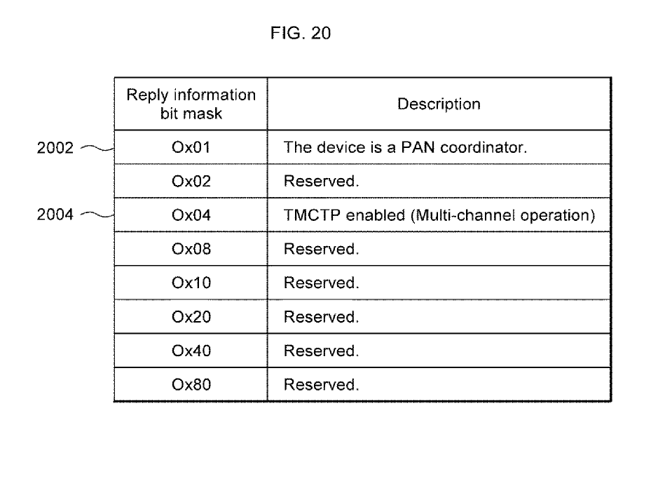

The reply status 1910 will be described with reference to FIG. 20.

FIG. 20 is an exemplary drawing for explaining the reply status included P2P-RP message according to one embodiment of the invention.

Referring to FIG. 20, the reply status can include at least one of the destination node type 2002 and TMCTP usage 2004.

On the other hand, each node calculates the metric of the route, or the link cost, and adds it to the SANN message or the P2P-RQ message, whenever SANN message or P2P-RQ message is transmitted from node to node, or SANN message or P2P-RQ message is forwarded.

Equation 1 shows the metric of route recorded when a control message, that is SANN message or P2P-RQ message, is transmitted to hop. The nodes forwarding SANN message or the P2P-RQ message can calculate the metric according to Equation 1 and additively insert it to the SANN message or the P2P-RQ message.

$$LinkCost = [ O + \frac{{b}_{t}}{r} ] [ 2 - \frac{{S}_{O}}{{B}_{O}} ] \frac{1}{1 - {e}_{f}} \qquad [ Equation 1 ]$$

In Equation 1,

$$[ O + \frac{{b}_{t}}{r} ]$$

shows the channel access overhead. Here, “0” shows the delay waiting overhead of hardware necessary for channel access; bₜ shows the size of standard packet (or test frame); and r shows the data rate of node.

$$[ 2 - \frac{{S}_{O}}{{B}_{O}} ]$$

shows the overhead of inactive duration and its value can be processed as 1 when the value is “0”. At the moment, Bₒ can be the same or bigger than Sₒ.

Here, Bₒ means the beacon order and Sₒ means the superframe order.

$$\frac{1}{1 - {e}_{f}}$$

shows the link error rate. The link error rate can be an average error rate, a maximum error rate or the like. In one embodiment of the invention, the link state of two nodes can be measured by the average error rate. The smaller the value of

$$\frac{1}{1 - {e}_{f}} is ,$$

the better condition of the route is. Here, e_{f} means the frame error rate of bₜ.

In another embodiment of the invention, the metric described in Equation 2 can be used. [Equation 2] is a method that the transmission estimation time according to the channel access and the error rate is summed with the waiting time.

$$LinkCost = [ O + \frac{{b}_{t}}{r} ] \frac{1}{1 - {e}_{f}} + [ \frac{\frac{1 / 2 {( {B}_{O} - {S}_{O} )}^{2}}{{B}_{O}}}{{B}_{O}} ] \qquad [ Equation 2 ]$$

The exemplary embodiment of the present invention can be implemented by various method. For example, the exemplary embodiment of the present invention can be implemented by using hardware, software or its combination. When they are implemented by software, they may be implemented as software executing in more than one processors using various operating systems or platforms. In addition, the software may be created by using any language among various appropriate programming languages or be compiled in machine language codes or intermediate codes executable in a framwork or virtual machine.

In addition, when the exemplary embodiment of the present invention is executed in more than one processors, the exemplary embodiment of the present invention may be implemented by processor readable media such as a memory, a floppy disk, a hard disk, a compact disk (CD), an optical disk or a magnetic tape, or the like in which more than one programs are recorded to conduct the implementation of various exemplary embodiments of the present invention.

What is claimed is:

1. A network route generating method by PAN (Personal Area Networks) coordinator which can transmit/receive message with node existing in TMCTP (TVWS Multichannel Cluster Tree Personal area networks) through a plurality of channels belong to TVWS (TV white space), the method comprises:
receiving a route search message from a SPC(Super PAN Coordinator) or an upper PAN coordinator, through a channel among the plurality of channels; and
broadcasting the route search message, through the plurality of channels.

2. The method of claim 1, wherein the broadcasting the route search message comprises:
broadcasting the route search message when a channel change between the plurality of channels is made.

3. The method of claim 1, further comprises:
generating a response message for the route search message; and
transmitting the response message to the SPC or the upper PAN coordinator through the channel.

4. The method of claim 3, further comprises:
receiving an ACK frame for the response message from the SPC or the upper PAN coordinator.

5. The method of claim 3, wherein the response message comprises a list of PAN nodes associated with PAN through the PAN coordinator.

6. The method of claim 1, further comprises:
receiving a response message for the route search message, from a lower PAN coordinator which receives the broadcasted route search message; and
transmitting the response message to the SPC or the upper PAN coordinator, through the channel.

7. The method of claim 6, wherein the response message comprises a list of PAN nodes associated with PAN through the lower PAN coordinator.

8. The method of claim 1, wherein the route search message comprises an L2R (Layer 2 Routing) capability of the SPC.

9. A network route generating method by a PAN (Personal Area Networks) coordinator which can transmit/receive message with nodes existing in TMCTP (TVWS multichannel cluster tree personal area networks) through a plurality of channels belong to TVWS (TV white space), the method comprises:
receiving a route search message from an upper PAN coordinator or a source PAN node, through a channel among the plurality of channels; and
broadcasting the route search message, through the channel.

10. The method of claim 9, further comprises:
generating a response message to the route search message and transmitting the response message to the source node or the upper PAN coordinator, if a destination PAN node is an own PAN node based on analyzing result of the route search message.

11. The method of claim 10, further comprises:
receiving an ACK frame to the response message.

12. The method of claim 9, further comprises:
broadcasting the route search message through the plurality of channels, if a destination PAN node is not an own PAN node based on analyzing result of the route search message.

13. The method of claim 9, further comprises:
setting the upper PAN coordinator as an upper node of the route.
